(19) United States
(12) Patent Application Publication
(10) Pub. No.: US 2026/0326213 A1
(43) Pub. Date: Oct. 22, 2026

(54) METHOD FOR PROCESSING SPECTACLE LENS BLANKS AND SPECTACLE LENS BLANK AS SEMI-MANUFACTURED PRODUCT AND DEVICE FOR CARRYING OUT THE METHOD

(71) Applicant: Roland Mandler GmbH & Co. KG, Heuchelheim (DE)

(72) Inventor: Roland MANDLER, Heuchelheim (DE)

(73) Assignee: Roland Mandler GmbH & Co. KG, Heuchelheim (DE)

(21) Appl. No.: 19/632,538

(22) Filed: Mar. 30, 2026

(30) Foreign Application Priority Data
Apr. 16, 2025 (EP) 25170875.6
Apr. 16, 2025 (EP) 25170882.2

(51) Int. Cl. B23C 3/12

(52) U.S. Cl. CPC B23C 3/12; B23C 2215/40

(57) ABSTRACT

A method and a device processes spectacle lens blanks, wherein the spectacle lens blank has a rim region and an inner region in which the region of a final spectacle lens is arranged. Due to the removal of projecting material with a milling tool in the rim region, an edge delimiting the inner region is formed, and milling is carried out during the milling operation in the rim region to a depth that is below the height of the edge delimiting the inner region. The spectacle lens blank, formed as a semi-manufactured product, has a surface in the inner region that is free-standing and projects over the remaining spectacle lens blank and is elliptical in top view.

### CROSS REFERENCE TO RELATED APPLICATIONS

Applicant claims priority under 35 U.S.C. §119 of European Application No. 25170875.6 filed on Apr. 16, 2025 and European Application No. 25170882.2 filed on Apr. 16, 2025, the disclosures of which are incorporated by reference.

### BACKGROUND OF THE INVENTION

### 1. Field of the Invention

The invention relates to a method for processing spectacle lens blanks and to a spectacle lens blank as a semi-manufactured product and to a device for carrying out the method.

### 2. Description of the Related Art

Spectacle lenses are usually made of circular spectacle lens blanks, the diameters of which are usually considerably greater than those which would correspond to the dimensions of the spectacle lens to be made therefrom. This is because the size of spectacle lenses diverges. The spectacle lens blanks are either raw pieces (neither side having an optical effect) or semi-finished pieces (one side having an optical effect) made of plastic or mineral glass. The processing is carried out by means of machining on milling machines, rotating machines, grinding machines, or polishing machines.

For processing, the spectacle lens blanks must be clamped onto workpiece retainers of the machine tools. In order to ensure that not only the central processing area but also the rim region remains accessible for processing, in the processing methods known from practice, the spectacle lens blanks are fastened to so-called block pieces either on the front side or the back side depending on which side is to be processed. This operation is referred to as blocking. The blocked side is therefore the accommodated side and usually already has an optically effective surface which has been manufactured either via mechanical processing or has already been formed on the semi-finished piece by means of non-cutting shaping processes.

On the accommodating side, the block pieces have a structured connection surface for the blocking. For blocking, the block piece and the spectacle lens blank are clamped in a device in such a way that a gap remains between the two. This is filled with a molten connection material. The material used is Wood’s metal, heavy metal alloy, UV-curable adhesive, or other materials such as wax. After curing, the connection material adheres to the structured connection surface of the block piece by means of an interlock and/or a frictional connection and to the accommodated side of the spectacle lens blank by means of adhesive forces (adhesive effect), wherein a layer of protective lacquer or a protective film on the spectacle lens blank often supports the adhesive effect.

It is disadvantageous that the blocking is time-consuming and costly. In addition, approximately two grams of heavy metal are lost per blocked spectacle lens blank in the processing. This corresponds to an environmental impact of approximately 500 to 700 metric tons of heavy metal in the production of 500 million spectacle lenses per year. When a UV-curing adhesive is used, large amounts of plastic waste are produced every year.

One other disadvantage of the wax and plastic blocking method is an impairment of already present optically effective surfaces due to the high heat input during blocking. In addition, the block pieces have a clamping rim in the form of a cylindrical circumferential surface with which they are clamped in the clamping tools of the processing machines. After the blocking, the block piece with the spectacle lens blank fastened thereto is fastened in or on a processing machine.

A lens holder is known from the prior art (US 12,059,768 B2), which is fixedly connected to the spectacle lens during the entire production of the spectacle lens. The fastening takes place at the beginning of production, the detachment at the end of the processing. In order to carry out industrial production on the basis of this transfer holding concept, many hundreds of very expensive holders are necessary. In automatic production, approximately 1,000 to 2,000 vacuum mounts per cell are necessary depending on the production size. These costs are not irrelevant. In addition, during the manufacture of the holders, the front curves of the spectacle lens blanks must be determined in advance. Making a subsequent change to the front curves would result in very high costs. This means that these block pieces belonging to the prior art are highly inflexible and costly.

Also belonging to the prior art (EP 2 631 033 A2) are a device and a method that permit block piece-free production of spectacle lenses. According to this prior art, a workpiece spindle is provided for each front curve. This device has six retainers for six front curves. This device belonging to the prior art has the disadvantage that the machine structure is highly complex and costly. Due to the provision of a specific and expensive workpiece spindle for each existing front curve, which must be clamped, the number of possible front curves of the spectacle lenses that can be used for production according to a prescription is limited on the one hand. On the other hand, the costs are enormously high, since the price for these workpiece spindles is in the five-digit euro range. This means that, when five to six different front curves are used, which is an enormous limitation, the costs for the workpiece spindles alone are in the six-digit euro range.

According to this prior art, a retaining rim region and a prescription lens region are also provided. The retaining rim region continues tangentially connected to the prescription lens region, however. The geometry of the interior prescription lens region is due solely to the manufacture of the spectacle lens. The retaining rim region is used to optimize further work steps. This is to be designed in such a way, however, that processing steps can be carried out precisely in the prescription lens region. Due to the tangential adjacency of the prescription lens region and the retaining rim region, a gradual transition between the prescription lens region and the retaining rim region is given. This means, the mathematical derivative is the same on both sides of the virtual spectacle frame line or, in other words, there is no sharp bend in the surface. Thus, a tool can be moved over the virtual spectacle frame line during precision grinding and/or polishing of the prescription lens region without compression occurring across the edges.

This means that the rim region is also processed, however, during the precision processing. In particular in the rim region, this means that the entire spectacle lens blank is processed with the diamond tools of the turning tool. A typical useful life during turning is 1,000 to 1,500 spectacle lenses, which in turn corresponds to a certain turning length, which can be calculated by calculating the length of the spiral length per lens.

This length per lens multiplied by 1,000 or 1,500 spectacle lenses then yields the total useful life of the tool.

Further belonging to the prior art (DE 10 2021 004 831 A1) is a method for machining optical workpieces, in particular spectacle lenses, made of plastic. According to this prior art, the spectacle lens blank, also referred to as a "blank," is processed in such a way that the spectacle lens blank is clamped in a block piece-free manner for processing. A groove or a step or a recess is circumferentially formed on the front side of the blank. The blank is then re-clamped such that the processing of the back side is possible. During the material removal of the semi-manufactured product to obtain the predetermined surface geometry, the semi-manufactured product is completely separated from the excess, radially outer material of the blank. This method belonging to the prior art uses a workpiece retainer which fixes the blank or the semi-manufactured product by means of a vacuum, for example. This method is highly complex, since the blank must be re-clamped once for processing the back side after the processing of the front side.

In the workpiece holders known from practical application, a distinction is made between the following types of fastening depending on the holding method for glass workpiece holders:
alloy fastening,
fastening with a UV adhesive,
fastening using adhesive films,
fastening using vacuum mounts,
fastening using thermal adhesives or wax.

These holding technologies used in practical application, with the exception of fastening using adhesive film and using vacuum fastening, are very highly polluting. The fastening using alloy (Wood’s metal) was already explained above.

Although holding the spectacle lens blanks with UV-curing or thermal adhesive material is less toxic than alloy blocking, it also has a very negative effect on the environment since an enormous amount of plastic waste is created. The UV holders and the adhesives must be disposed of.

The method using the adhesive film is the method with the fewest environmental problems combined with very good results. Until now, however, this could not be used industrially in automatic production for technological reasons.

### SUMMARY OF THE INVENTION

The technical problem underlying the invention is that of providing a method for processing spectacle lens blanks, which has a considerably shortened processing time and in which the wear on the turning tool can be considerably reduced. Furthermore, a spectacle lens blank is to be provided as a semi-manufactured product, with which the working time and the wear are considerably reduced. In addition, a method is to be provided, which also enables a shortened processing time.

This technical problem is solved by method having the features according to one aspect of the invention, by a spectacle lens blank having the features according to another aspect of the invention, and by a device having the features according to a further aspect of the invention.

The method according to the invention for processing spectacle lens blanks for manufacturing spectacle lenses with at least one milling operation and at least one turning operation, wherein projecting material of the spectacle lens blank is milled off in the milling operation, wherein fine processing of the milled surface of the spectacle lens blank is carried out in the turning operation, and wherein the spectacle lens blank has a rim region and an inner region in which the region of a final spectacle lens to be processed is arranged, is characterized in that, by removing the projecting material in the rim region, an edge delimiting the inner region is formed, and in that milling is carried out during the milling operation in the rim region to a depth that is below the level of the edge delimiting the inner region.

The method according to the invention has the advantage that the spectacle lens blank, which has a considerably greater diameter than the finished spectacle lens, and in which projecting material is removed, is processed with the milling tool in such a way that a rim region is produced and remains intact by achieving a milling depth that is below the height of the edge that delimits an inner region of the spectacle lens blank.

According to the invention, an edge delimiting the inner region is formed in the rim region with the milling tool and, during the milling operation, milling is carried out in the rim region to a depth that is below the height of the edge delimiting the inner region.

The delimiting edge can have various shapes. It can be designed as a sharp edge with a sharp bend or as a rounded edge. Other embodiments are also possible.

Thus, a free-standing ellipse is produced during the milling operation. This free-standing ellipse, for example in the form of an island, is the region that is subsequently processed in the fine processing.

Since the rim of the spectacle lens blank does not need to be processed with the turning tool, the processing time for the fine processing of the spectacle lens blank is considerably reduced. Furthermore, the useful life of the turning tool is considerably increased.

The inner region corresponds to the prescription lens region. The inner region advantageously has a slightly larger diameter than the prescription lens region, such that the spectacle lens can be fit into various spectacle frames.

Due to the milling operation, a height topography of the surface of the spectacle lens blank is produced, which, from the rim to the edge delimiting the inner region, does not correspond to the final topography of the finished spectacle lens, but rather to a deeper surface. The inner region corresponds, in the processing, to the subsequent freeform surface with a thickness allowance. The thickness allowance can advantageously lie between 0.1 mm and 0.5 mm. Preferably, the thickness allowance lies between 0.2 mm and 0.3 mm.

Due to the processing according to the invention, a free-standing elliptical surface in the form of an island on the spectacle lens blank is produced.

This free-standing elliptical surface is also referred to as a best-fit elliptical surface.

The allowance is removed in a second or a following work process, namely in the fine processing. Since the surface of the finished spectacle lens is considerably smaller than the surface of the spectacle lens blank, the processing time is considerably reduced, since fewer revolutions are necessary for the processing. In addition, the tool wear is considerably less, since less rotational distance is present.

The technological advantage can be up to 50%. A typical diameter of an inner region of the spectacle lens blank is approximately 55 mm, which means, according to the invention, that advantageously only approximately 920 revolutions are necessary for a planar surface in order to process the surface of the inner region of the spectacle lens blank. Since the rotational distance of the spiral decreases considerably with a smaller diameter, the effect on the working time and the wear is disproportionate to the savings in the number of revolutions, which is reduced.

According to the prior art, for example 1,100 revolutions are required for a planar surface with a disproportionately longer rotational distance.

A further advantage of the processing with the method according to the invention is that the raw thickness for a spectacle lens blank (blank) can be reduced by approximately 50%, since the rim thickness of the spectacle lens along an imaginary line for a spectacle frame is considerably less than at the outer rim. This applies in particular for minus lenses.

For plus lenses, it is the other way around. Here, the necessary central thickness of the spectacle lens blank is reduced. In any case, the method according to the invention has a great positive influence on the sustainability of the production of spectacle lenses.

According to a further advantageous embodiment of the invention, it is provided that the rim region is retained at least during the milling operation and the turning operation.

According to a particularly preferred embodiment of the invention, the rim region is also retained during a subsequent polishing operation and/or a subsequent coating. As a result, it is possible to use standardized holders, for example, for the coating operation. The holders thus tightly surround the rim of the spectacle lens, such that the coating is applied only on the side of the spectacle lens that is being coated.

According to a further advantageous embodiment of the invention, it is provided that a shape having a concave cross-section is formed in the rim region during the milling operation, which shape is milled between the outer rim of the spectacle lens blank and the edge of the spectacle lens blank delimiting the inner region.

If a milling tool, for example with a spherical cutter, is used, a concave shape can be easily formed. The concave shape is delimited by the outer rim of the spectacle lens blank on the one hand and, on the other hand, by the edge that delimits the inner region, i.e., the prescription lens region.

Due to the concave shape, a rim region is produced, which has a height that is less than the height of the edge delimiting the inner region.

The concave shape can advantageously be designed to be uniform.

According to a further advantageous embodiment of the invention, the rim region of the spectacle lens blank additionally has an indentation on the front side. This indentation is advantageous when a plus lens is manufactured, such that the rim region of the finished spectacle lens does not become sharp-edged and easily becomes damaged during the further production steps.

According to a further advantageous embodiment of the invention, it is provided that, in a first work step with a milling operation, the outer diameter of the spectacle lens blank is milled off to a standard outer diameter, wherein the standard diameter is greater than the inner region.

According to this embodiment, the spectacle lens blank is advantageously milled off to a standard outer diameter in the first work step. As a result, the use of workpiece holders is considerably simplified, since the spectacle lens blanks all have the same standard outer diameter.

This standard outer diameter is great enough, however, that the above-described rim region is present.

According to a further advantageous embodiment of the invention, it is provided that the projecting material of the spectacle lens blank is milled off in a circular spiral that transitions into an elliptical spiral path and that corresponds to the freeform surface of the final spectacle lens.

As a result, the rim region is retained. In this method step, a thickness allowance of, for example, 0.2 mm to 0.3 mm is also retained, such that subsequent fine processing, for example with a turning tool, is possible and the remaining material can be removed in the fine processing.

According to a further advantageous embodiment of the invention, it is provided that the spectacle lens surface is processed with the milling tool within the inner region and that the spectacle lens surface with an allowance is formed.

This allowance is provided such that this allowance can be removed in the fine processing, for example with a turning tool, and thus the freeform surface can be produced in the prescription lens region, i.e., in the inner region.

According to a particularly preferred embodiment of the method according to the invention, it is provided that the fine processing operation is carried out with at least one turning tool. There is the possibility to carry out the fine processing operation, for example, with a turning tool or with two different turning tools in succession.

The turning tools preferably carry cutting bits which in turn are advantageously equipped with diamonds.

According to a further advantageous embodiment of the method according to the invention it is provided that the rim region is milled off after the fine processing or after a coating of the spectacle lens or after another processing step.

If the spectacle lens is further processed for insertion into a spectacle frame, the rim region is no longer required. For this reason, the rim region can be milled off after the required processing steps.

The spectacle lens blank according to the invention, formed as a semi-manufactured product, manufactured according to the method according to the invention, is characterized in that a surface is formed in the inner region that is free-standing and projects over the remaining spectacle lens blank and is elliptical in top view. This elliptical surface is also referred to, for example, as a so-called best-fit surface.

The spectacle lens blank according to the invention is formed as a semi-manufactured product, i.e., the rim region is processed with the milling tool, specifically according to the method according to the invention. Even after the removal of projecting material, a surface remains in the inner region, which is the prescription lens region, that is free-standing and projects over the remaining spectacle lens blank and is elliptical in top view.

For the further fine processing, all that is necessary is to process this elliptical surface, whereby a considerable time savings and also an increase in the useful life of the tool, for example of the diamond tool, is ensured.

According to an advantageous embodiment of the invention, it is provided that the projecting surface, which is elliptical in top view, is formed as a freeform surface for the spectacle lens to be manufactured, plus an allowance.

With the milling tool, the projecting surface, which is elliptical in top view, is processed in such a way that the so-called prescription surface, i.e., the freeform surface that is desired, is formed. A thickness allowance of 0.1 mm to 0.5 mm, preferably 0.2 mm to 0.3 mm, remains.

This allowance is provided so that projecting material can be removed in the fine processing.

The device according to the invention for processing spectacle lens blanks with at least two tools for processing the spectacle lens blanks, wherein the device has a plurality of work areas, wherein a loading device for the spectacle lens blanks and an unloading device for the spectacle lenses manufactured from the spectacle lens blanks is arranged in one work area, is characterized in that
a tool holder, which is rotatable about a first axis, with at least two tool-holding devices for the tools is arranged in a first work area,
a magazine for at least two workpiece holders is provided in a second work area,
the loading and unloading device is arranged in a third work area, and
a fourth work area is provided, in which a workpiece spindle with a retainer for a workpiece holder is arranged, wherein the workpiece spindle is designed to be positionable about a second axis.

The device according to the invention has the advantage that cost-effective processing of standardized spectacle lens blanks is possible with the device.

The device has a plurality of work areas, wherein a first work area has a tool holder with at least two tool-holding devices for the tools. The tool holder is designed to be rotatable, such that the various tools can be oriented in the direction of a tool spindle.

In a second work area, a magazine for at least two workpiece holders is provided. Advantageously, four to twelve workpiece holders are provided. More or fewer workpiece holders can also be provided, however.

The magazine is advantageously designed as a magazine plate, preferably as a round magazine plate. The magazine can also be designed as an elongate magazine, however, for example as a bench for accommodating workpiece holders. The elongate magazine is advantageously designed to be linearly displaceable. An elongate magazine has the advantage that the number of places for workpiece holders is unlimited. A round magazine plate has the advantage that it can have a simple central mounting for rotation and displacement.

In a third work area, the loading and unloading device is arranged, with which the spectacle lens blanks from a transport device can be arranged in a workpiece holder, and with which the processed spectacle lenses can be supplied back to the transport device.

In a fourth work area, a workpiece spindle with a retainer for a workpiece holder is arranged, wherein the workpiece spindle is designed to be positionable about a second axis. A workpiece holder which is suitable for a spectacle lens blank can be arranged in the retainer.

The manufacture of spectacle lenses with mechanical processing technology is advantageously carried out using spectacle lens blanks which are formed in the shape of a disk or in the shape of a meniscus. The raw diameter is usually 65 mm to 85 mm and the thickness is approximately 10 mm to 12 mm. The convex front curve is usually already fully finished and is used as the base of the prescription for manufacturing the second surface on the concave side of the spectacle lens both for the fastening during the processing and for mathematically calculating the spectacle lens prescription.

Basically, the blank type should be selected on the basis of a prescription. A prescription is to be considered to be the documentation by a physician or optician as well as any information about a vision defect. The vision defect can also be a standardized vision defect for (small) series production. The mount of a desired spectacle frame may possibly also be decisive for the selection of the blank type, however.

Due to the combination of the convex front side in connection with the concave back side, the so-called prescription effect of the spectacle lens is created. This effect is expressed in diopters. This can be a purely spherical plus or minus effect, or even an astigmatic effect or even a progressive or bifocal effect. A combination of these properties is also possible. In modern production nowadays, there is mention of a freeform surface on the inner side and also of a freeform spectacle lens. All medically necessary vision corrections can thus be implemented nowadays with very high accuracy using these freeform spectacle lenses.

With the workpiece holders that are arranged in the magazine of the device according to the invention, it is possible to accommodate spectacle lens blanks with different surface curvatures. During a processing of the surface, an accommodated spectacle lens blank is thus always braced from the direction of the accommodated side, which is not to be processed, by means of the workpiece holder accommodating surface. The surface geometry to be processed can be produced in a correspondingly precise manner. Despite the different surface curvatures, the thickness of produced spectacle lenses can be minimized.

One further advantage of the device according to the invention is that the workpiece is retained directly in the device and not by means of upstream and partially manual work steps, as is the case with blocking. Therefore, the processing speed is high. The workpiece retainers are ready for use in the magazine. The workpiece spindle accommodates the workpiece holder that is required to process the relevant spectacle lens blank. This process can be advantageously carried out in an automated manner in order to shorten the processing time.

One further advantage of the device according to the invention with the magazine for the at least two workpiece holders is that, in comparison with the prior art, in which, for example, only six workpiece holding devices are arranged on a workpiece revolver, more different workpiece holders can also be arranged in the magazine and can be available. Thus, the device according to the invention is usable in a more versatile manner, namely for a larger number of spectacle lens blanks with different front sides.

The device according to the invention has the loading and unloading device in a third work area. If the workpiece holder which is suitable for the next spectacle lens blank is arranged on the workpiece spindle, then, in the loading and unloading station, the spectacle lens blank is preferably automatically removed from a transport device and arranged on the workpiece holder. The spectacle lens blank is fastened on the workpiece spindle via the workpiece holder for the period of time of the processing.

The device according to the invention also has a fourth work area in which the workpiece spindle with a retainer for the workpiece holder is arranged. The workpiece spindle is designed to be positionable about a second axis. The workpiece spindle can be arranged with the retainer for the workpiece holder in the second work area in order to remove a workpiece holder from the magazine or to place same there. It can be arranged in the third work area for the loading or unloading with the workpiece holder. Furthermore, it can be arranged with the workpiece holder and the spectacle lens blank arranged thereon in the first work area such that mechanical processing of the spectacle lens blank is carried out.

Particularly advantageously, the entire method runs in an automated manner.

Due to the fact that at least two tools can be arranged in the tool-holding devices on the rotatable tool holder, it is possible to process the spectacle lens blank using different tools.

Particularly advantageously, two tool-holding devices are provided. It is also possible, however, to arrange more than two tool-holding devices in the tool holder.

The advantage of the device according to the invention is considered to be, on the one hand, that block piece-free processing of the spectacle lens blanks is possible, on the other hand, however, that more than six different workpiece retaining surfaces are available for the spectacle lens blanks, such that more than six different blank types can be accommodated.

One further advantage of the device according to the invention is that the work processes for producing the prescription lenses are considerably reduced.

Due to the fact that an adapted workpiece holder is available in the magazine of the device for each type of spectacle lens blank, optimal support is provided during the processing of the spectacle lenses. Thermally induced stress due to the fastening method does not occur.

With the device according to the invention, both cost-effective production and the possibility of a stably supported spectacle lens blank and thus a highly accurate production method for spectacle lenses are possible.

With the device according to the invention, fully automatic production can be carried out with a minimum number of production steps.

According to an advantageous embodiment of the invention, the first axis and the second axis are oriented perpendicularly to one another. The tool holder is rotatable about the first axis in order to be able to orient the at least two tool-holding devices in the direction of the workpiece spindle depending on the tool with which processing is to be carried out. The second axis is the axis about which the workpiece spindle is rotatable and positionable. The workpiece spindle rotates about the second axis in order to arrange the retainer for the workpiece holder and optionally the workpiece holder arranged thereon in the region of the magazine and to position the workpiece holder in the region of the loading and unloading station or in the region of the tools.

According to a further advantageous embodiment of the invention, it is provided that the workpiece spindle is designed to be positionable about the second axis in the direction of the first or of the second or of the third work area. As a result, it is possible to pick workpiece holders out of the magazine or to deposit them there. It is also possible to accommodate unprocessed spectacle lens blanks in the workpiece holder or to unload the processed spectacle lens blanks. Furthermore, it is possible to process the spectacle lens blanks by means of the at least two tools.

According to a further advantageous embodiment of the invention, it is provided that the workpiece spindle is designed to be additionally driven rotationally about a spindle axis. Thus, not all production movements need to be carried out by means of any tools. Rather, advancing movements, for example from a cutting bit, also suffice. In addition, the position of the accommodated spectacle lens blank stabilizes due to the rotation, which results in a high surface quality during processing.

According to a further advantageous embodiment of the invention, it is provided that the first and the second and the third work areas are arranged radially with respect to the second axis of the workpiece spindle. This embodiment has the advantage that the retainer of the workpiece spindle for the tool holder is positionable in every work area. The retainer of the workpiece spindle for the workpiece holder can be arranged in the second work area in order to pick a workpiece holder out of the magazine or to deposit same there. The accommodated workpiece holder can be arranged in the third work area of the loading and unloading station for the spectacle lens blanks and the workpiece holder with the spectacle lens blank can be positioned in the first work area for processing using the at least two tools.

According to a particularly preferred embodiment of the invention, it is provided that a milling tool and a turning tool having at least one cutting bit for processing a surface of the spectacle lens blanks are arranged in the tool-holding devices.

In a first work step, a milling operation is advantageously carried out. Particularly advantageously, a spherical cutter is provided, with which rapid rough processing of the spectacle lens blank can be carried out. To this end, the milling tool can have an outer circumference program, for example, for processing the outer radial contour of the spectacle lens blank. Additionally, a surface processing program for the optical surface can bring about a considerable time savings. Finally, the milling tool can include an orientation groove program in order to provide the spectacle lens blank with an orientation marking for subsequent work steps.

Above all, spherical cutters, the diameter of which perpendicular to the milling spindle is equal to or similarly equal to its extent in the direction of the milling spindle, are suitable for such processing steps. In particular, spherical cutters with a diameter from 20 mm to 60 mm are advantageous. Other diameters are also suitable, however.

The milling spindle rotates, for example, at 30,000 revolutions per minute. Other rotational speeds are also possible.

Provided requirements exist that cannot be met by the aforementioned spherical cutter alone, a supplementation is possible in such a way that the milling tool includes a tool revolver with at least one further second milling cutter differing from the first spherical cutter.

It is also possible to arrange one further milling tool on the tool holder, such that two milling tools and one turning tool, for example, are arranged on the tool holder.

Thus, a suitable milling cutter can be selected depending on the requirement. A manual tool change is not necessary.

Furthermore, according to the invention, a turning tool is advantageously arranged on the tool holder. The turning tool with a, for example advanceable, cutting bit is used to manufacture particularly fine structures of the optical surface to be processed. To this end, the turning tool advantageously has a surface program. The necessary rotational movements of the spectacle lens blank can be implemented by rotating the workpiece spindle about its spindle axis. Since the optical surfaces of the processing side are not rotationally symmetrical in most cases, the turning tool advantageously has a so-called fast tool servo drive. This is a particularly fast and precise actuator. Such can be driven with piezo elements, for example. Alternatively, linear motors and plunger coil actuators (voice coil actuators) are suitable.

If all requirements cannot be met by a single cutting bit, the cutting bit tool can be equipped with at least one second cutting bit differing from the first cutting bit.

Furthermore, the turning tool should be mounted in such a way that it can change the angular position during the surface program relative to the spindle axis of the workpiece spindle in an open-loop-controlled manner. Thus, micro-grooves in the surface can be reduced.

The load on the workpiece spindle and thus any vibrations are avoided in the best way possible when the turning tool and the milling tool are arranged opposite one another relative to the main rotational axis of the workpiece spindle. Provided they are arranged here geodetically horizontally opposite one another, a mutual impairment due to coolant and swarf is also avoided.

According to a particularly preferred embodiment of the invention, it is provided that the milling tool with a spherical cutter, which is rotatable about a milling spindle and is advanceable, is arrangeable in the first work area, or that the turning tool having the at least one cutting bit is arrangeable in the first work area.

This embodiment has the advantage that rough processing with the milling tool and the fine processing with the turning tool are executable in a single work area.

According to a further advantageous embodiment of the invention, it is provided that the loading device for loading the spectacle glass blanks and the unloading device for unloading the spectacle lenses manufactured from the processed spectacle lens blanks are arranged in the third work area and that the loading device and the unloading device are a single device. The loading and unloading can be carried out with one and the same device.

Advantageously, the spectacle lens blanks are supplied via a transport device which has transport boxes, for example. The processed spectacle lens blanks are in turn supplied to the transport device, for example to the transport boxes. The spectacle lens blanks are processed in the device according to the invention.

In the present application, the processed spectacle lens blanks are referred to as spectacle lenses. These spectacle lenses do not yet need to be fully processed, however. A further post-processing, for example polishing or coating or removing a projecting rim or the like, can advantageously still be subsequently carried out.

According to a further advantageous embodiment of the invention, it is provided that the tool holder, which is rotatable about a first axis and is arranged in the first work area, is designed to be linearly displaceable. The tool holder is advantageously designed to be linearly displaceable in the direction of the workpiece spindle.

This linear displaceability is advantageous in order to permit automated processing of the spectacle lens blanks. The tool holder is rotated about a first axis in order to select the tool on the tool holder. Then, the tool holder is linearly displaced, such that the tool arranged on the tool holder can come into contact with the spectacle lens blank during processing. If a processing operation, for example the milling operation, has been completed, the tool holder is in turn advantageously linearly displaced, such that the tool no longer comes into contact with the spectacle lens blank. The tool holder is advantageously rotated about the first axis, such that the second tool, for example the turning tool, is advantageously oriented in the direction of the tool spindle. Then, the tool holder is advantageously linearly displaced once again, such that processing of the spectacle lens blank with the turning tool is possible.

According to a further advantageous embodiment of the invention, it is provided that the workpiece spindle with the retainer for the workpiece holder is designed to be linearly displaceable perpendicularly to its longitudinal axis and in the direction of the second axis.

This linear displacement axis of the workpiece spindle allows the spectacle lens blank to be processed in an optimal manner. This linear axis of the workpiece spindle, which can also be referred to as a transverse axis, is identical to the second axis or parallel to the second axis, about which the workpiece spindle is rotatable.

According to an advantageous embodiment of the invention, the magazine with the at least two workpiece holders is rotatable and positionable by 0 to 360 degrees. The magazine is advantageously driven by a motor and rotates about a third axis. The magazine is also linearly displaceable along the third axis. The magazine is advantageously moved and positioned in the direction of this linear axis, such that workpiece holders can be removed or deposited.

The transport device for the spectacle lens blanks and the spectacle lenses advantageously has transport boxes in which the spectacle lens blanks or the spectacle lenses are arranged.

Advantageously, furthermore, a loading system is provided, which is advantageously designed as a robot or as a collaborative robot or a cobot. A cobot is an industrial robot which is not separated from operating personnel by protective devices, for example, in the production process.

According to a further advantageous embodiment of the device, the device according to the invention is provided with a cladding which acts as a splash guard on the one hand and can perform a safety function on the other hand.

According to a further advantageous embodiment of the invention, a base unit is provided, on which the tool holder and a mounting of the workpiece spindle as well as the mounting of the magazine are arranged. Furthermore, the transport device is also advantageously arranged on or at the base unit. Additionally, the loading device can be advantageously arranged on the base unit.

The base unit advantageously consists of polymer concrete, granite, and/or gray cast iron, which is filled with core sand. Advantageously, the base unit is vibration-isolated and, particularly advantageously, optimized by means of a modal analysis.

The method according to the invention for processing spectacle lens blanks with the device according to the invention, wherein at least two spectacle lens blank types with different surface curvatures on the accommodated side are selectable, is characterized in that
the workpiece spindle with the retainer for the workpiece holder is positioned in the second work area,
in the second work area, a workpiece holder, which is suitable for the spectacle lens blank, from the magazine is arranged on the retainer on the workpiece spindle,
the workpiece spindle with the retainer for the workpiece holder and with the workpiece holder arranged on the retainer is positioned in the third work area,
a spectacle lens blank in the third work area is removed from a transport device with the loading device and arranged and fixed in or on the workpiece holder,
the workpiece spindle with the retainer for the workpiece holder and the workpiece holder arranged thereon and the spectacle lens blank arranged in or on the workpiece holder are positioned in the first work area,
the tool holder orients the first tool in the direction of the workpiece spindle,
the spectacle lens blank is processed with the first tool,
the tool holder orients the second tool in the direction of the workpiece spindle,
the spectacle lens blank is processed with the second tool,
the workpiece spindle with the workpiece holder and the spectacle lens arranged in or on the workpiece holder and manufactured from the processed spectacle lens blank is positioned in the third work area,
the spectacle lens manufactured from the processed spectacle lens blank is removed from the workpiece holder and deposited in the transport device by means of the unloading device.

The method according to the invention has the advantage that, in an advantageously fully automatic method, a spectacle lens blank can be removed from a transport device, that workpiece holders for a plurality of spectacle lens blank types are selectable from a magazine and arrangeable on a workpiece spindle, that the spectacle lens blank is processed with at least two tools, that the processed spectacle lens blank, i.e., the spectacle lens manufactured from the spectacle lens blank, which can be subjected to even further processing steps, is deposited in the transport device once again.

The method according to the invention also has the advantage that it can be carried out in a fully automated manner and that suitable tool holders are available for each of various spectacle lens blank types and are stored in the magazine, wherein the number of tool holders is limited only by the number of places in the magazine. As a result, optimized processing of the spectacle lens blanks is possible, since optimal storage of the spectacle lens blanks during the processing is provided by the adapted workpiece holders.

According to the method according to the invention, the spectacle lens blank is processed with at least two tools.

According to a further advantageous embodiment of the invention, it is provided that, as the last step, the workpiece spindle with the workpiece holder is positioned in the second work area and the workpiece holder is deposited in the magazine.

This method step is merely optional. If the next spectacle lens blank to be processed has a front side with the same curvature as the preceding spectacle lens blank, the workpiece holder does not need to be deposited in the magazine and picked up once again; rather, the workpiece holder can remain on the workpiece spindle.

According to a further advantageous embodiment of the invention, it is provided that, between the processing of the spectacle lens blank with the first tool and the processing with the second tool, at least one further processing is carried out with at least one further tool, and/or that, after the processing with the second tool, at least one further processing is carried out with at least one further differing tool.

According to a particularly advantageous embodiment of the invention, the first tool is designed as a milling tool and the second or a further tool is designed as a turning tool having the at least one cutting bit.

Rough processing is carried out with the milling tool and fine processing is carried out with the turning tool which supports at least one cutting bit.

There is the possibility to carry out a further milling operation with a second milling tool after the first processing operation with the milling tool.

There is also the possibility to process the surface of the spectacle lens blank with two different turning tools.

For example, two processing operations can be carried out with two different milling tools and one processing operation can be carried out with a turning tool. There is also the possibility to carry out one processing operation with a milling tool and two processing operations with turning tools. Other alternatives are also possible.

According to a further advantageous embodiment of the invention, it is provided that a spindle axis of the workpiece spindle, a linear axis of the tool holder, and a transverse axis with respect to the longitudinal axis of the workpiece spindle interpolate during the milling processing.

The three axes interact during the milling operation in order to be able to manufacture a desired rough processing of the surface of the spectacle lens blank.

The processing is carried out in most cases in a specific movement about the spindle axis of the workpiece spindle from the rim to the center of the spectacle lens blank. Other kinematics are also possible, however.

According to a further advantageous embodiment of the method according to the invention, it is provided that the at least one tool is oriented toward the center of the workpiece spindle. As a result, a highly accurate processing, in particular of the center of the spectacle lens, is made possible, specifically precisely at the point where the spectacle lens must have the highest accuracy.

According to a further advantageous embodiment of the method according to the invention, it is provided that a combination of the movement of the workpiece spindle in the direction of a transverse axis of the workpiece spindle, which is arranged perpendicularly to the longitudinal axis of the workpiece spindle, and of the movement of the turning tool in the linear direction is carried out to orient the turning tool toward the center of the workpiece spindle. Due to this embodiment, the fine processing of the spectacle lens is carried out via the turning process, which is advantageously carried out in the form of a specific path from the rim of the lens contour to the center of the lens. Since the surface of the spectacle lens is a non-rotationally shaped freeform surface, the turning tool must move along the linear axis during every revolution of the lens and thus produces a portion of the freeform surface. At the same time, the axis of the workpiece spindle, the linear axis of the tool, and the transverse axis of the workpiece spindle interpolate. Due to the interpolation, the main linear movement for producing the freeform surface is generated. Other movements or interpolations are also possible in order to optimize processing properties.

The combination of the positioning of the second axis, about which the workpiece spindle rotates, in connection with the linear axis of the tool holder can be used to perfectly position the second tool, for example the cutting bit, toward the center of the workpiece spindle. As a result, the quality of the spectacle lens is optimized in the center.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the drawings

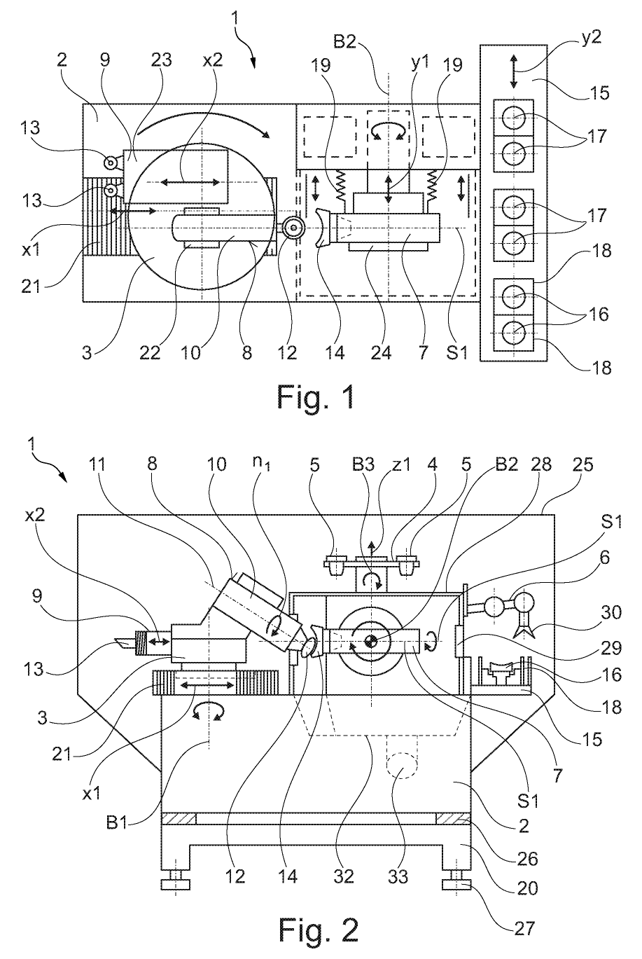

FIG. 1 shows a device according to the invention in top view;

FIG. 2 shows a device according to the invention in a side view, partially cut away;

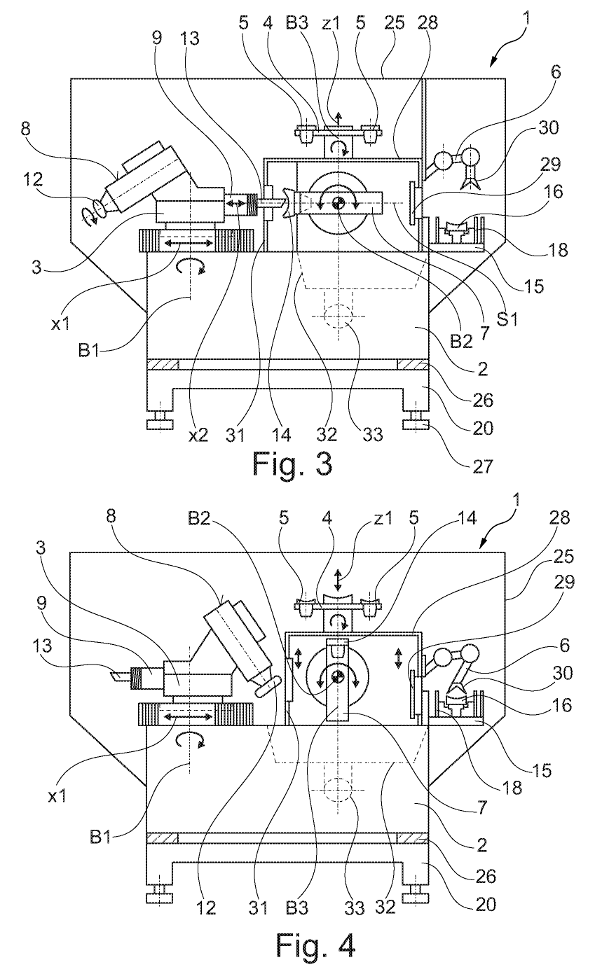

FIG. 3 shows the device according to the invention according to FIG. 2 with second tool;

FIG. 4 shows the device according to FIG. 2 with workpiece spindle in modified working position;

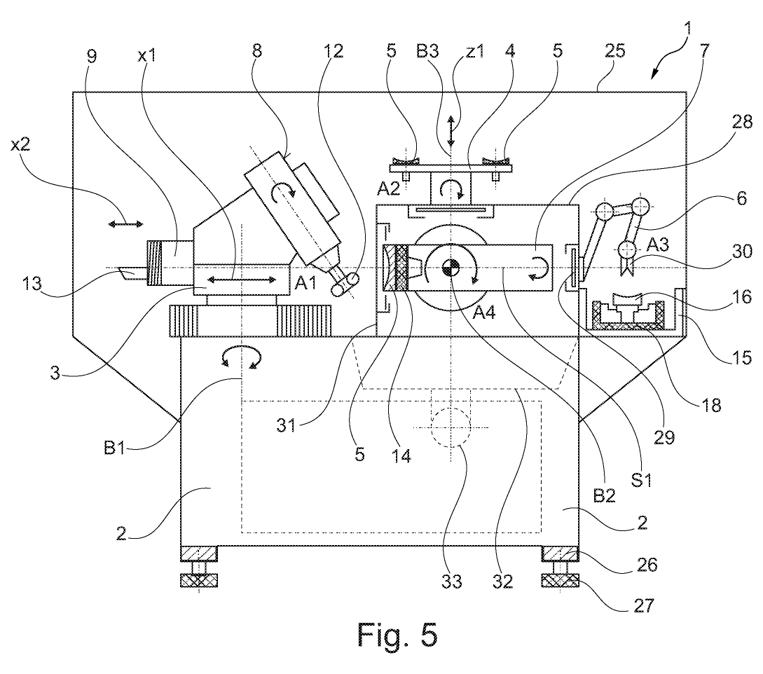

FIG. 5 shows the device according to the invention with modified working position of the workpiece spindle;

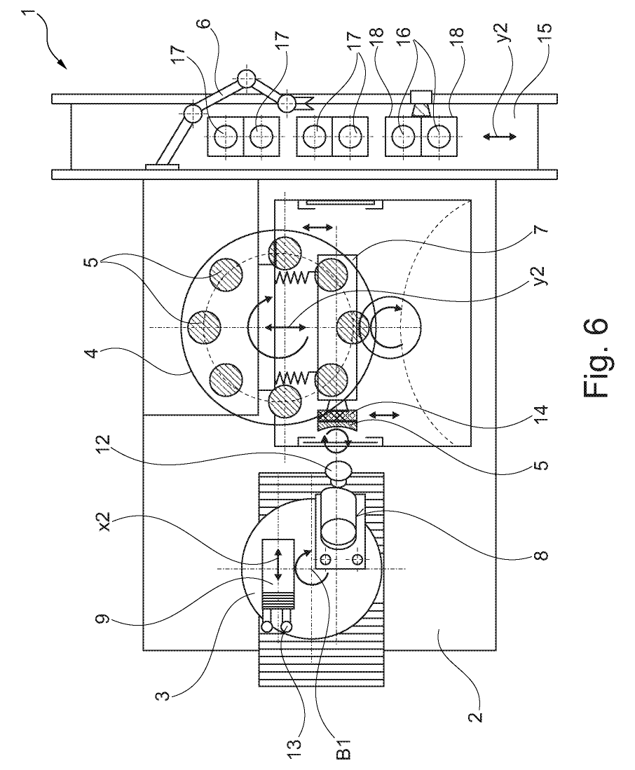

FIG. 6 shows the device according to the invention in top view,

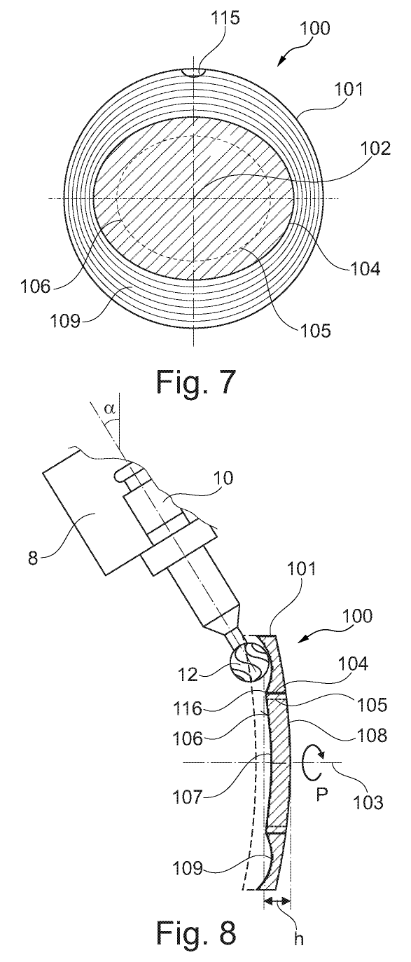

FIG. 7 shows a spectacle lens blank in top view;

FIG. 8 shows a spectacle lens blank in the cross-section during the rough processing;

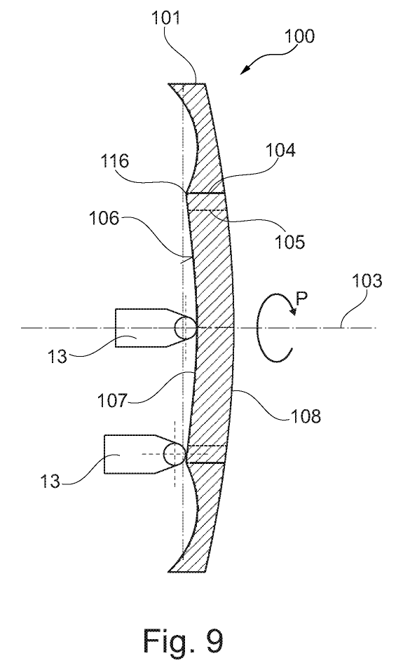

FIG. 9 shows a spectacle lens blank in cross-section during the fine processing;

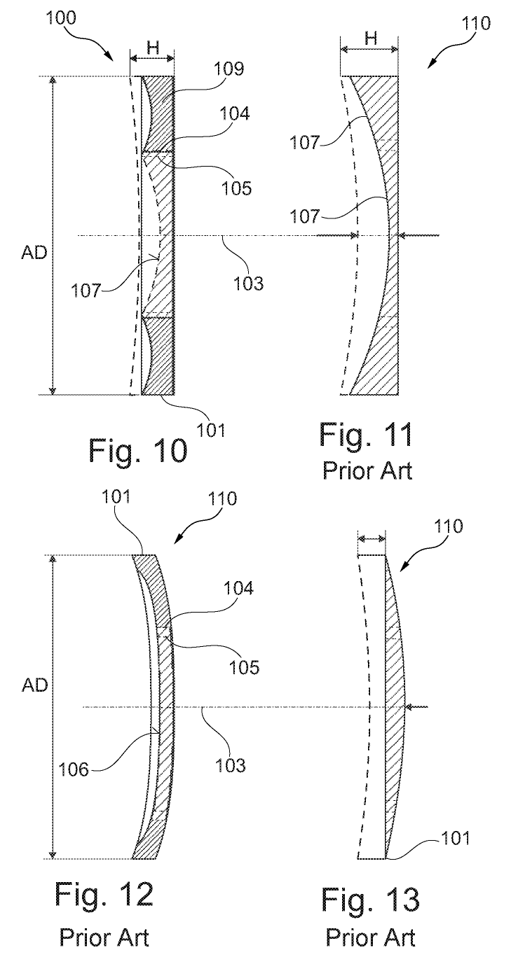

FIG. 10 shows a minus lens according to the invention in cross-section;

FIG. 11 shows a minus lens according to the prior art in cross-section;

FIG. 12 shows a plus lens according to the prior art in cross-section;

FIG. 13 shows a plus lens according to the prior art in cross-section; and

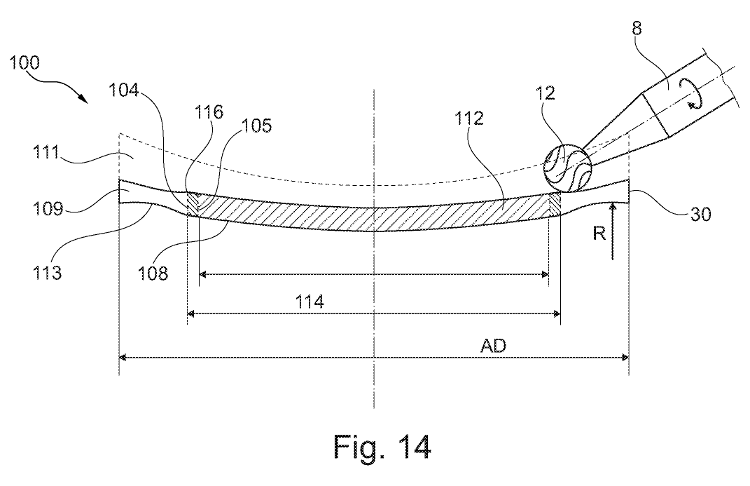

FIG. 14 shows a cross-section through a spectacle lens blank as modified exemplary embodiment.

### DETAILED DESCRIPTION OF PREFERRED EMBODIMENTS

FIG. 1 shows a device 1 according to the invention for processing spectacle lens blanks. FIGS. 2 through 6 also show the device 1. Identical parts are provided with the same reference characters.

The device 1 has a base unit 2. The device 1 has four work areas, which are designated in greater detail in FIG. 5. These are a first work area A1 with a tool holder 3 and a second work area A2 with a magazine 4 for workpiece holders 5. A loading and unloading device 6, which is represented only in FIGS. 2 through 6, is arranged in a third work area A3. A workpiece spindle 7 is arranged in the fourth work area A4.

The workpiece holders 5 are designed differently. The workpiece holders 5 have surfaces that are adapted to different spectacle lens blank types.

The tool holder 3 is arranged rotatably about a first axis B1. The workpiece spindle 7 is arranged rotatably about a second axis B2.

The workpiece holder 5 is positionable in different positions via rotation about the axis B3. The workpiece holder can rotate from 0 to 360 degrees about the axis B3.

The workpiece spindle 7 rotates about the axis B2. The workpiece spindle 7 is positionable in the direction of the work areas A1, A2, A3.

The tool holder 3 carries two tool-holding devices 22, 23. A milling tool 8 is arranged on the one tool-holding device 22 and a turning tool 9 is arranged on the other tool-holding device 23. The milling tool 8 has a milling spindle 10, which rotates about its longitudinal axis 11 with a rotational speed n1. In FIGS. 1 through 6, different spherical cutters 12 having different cross-sections are arranged on the milling spindle 10. In FIGS. 1, 2, 4, 5 and 6, the milling spindle 10 is arranged in the direction of the tool spindle 7. According to FIG. 3, the turning tool 9, which has two cutting bits 13, is arranged in the direction of the workpiece spindle 7.

The workpiece holder 5 is arranged displaceably in the direction x1 on the base unit 2. Furthermore, the turning tool 9 is mounted displaceably in the x2 direction on the tool holder 3.

The magazine 4 for the workpiece holders 5 is arranged in the second work area A2. The magazine 4 is mounted rotatably about a third axis B3. Furthermore, the magazine 4 is linearly displaceable in the direction z1.

The workpiece holders 5 can be removed from the magazine 4 and fastened to the workpiece spindle 7 by means of a retainer 14 arranged on the workpiece spindle 7. The workpiece retainer 14 is schematically represented in FIGS. 5 and 6. In FIGS. 5 and 6, a workpiece holder 5 is arranged on the retainer 14.

In the third work area A3, a loading and unloading device 6 is provided. The loading and unloading device 6 is designed as a robot or as a cobot. The loading and unloading device 6 removes spectacle lens blanks 16 from a transport device 15 which is designed to be movable in the direction y2. After the processing of the spectacle lens blanks 16, the loading and unloading device 6 deposits the spectacle lenses 17 manufactured from the spectacle lens blanks in the transport device 15.

The spectacle lenses 17 can be supplied to further processing. The spectacle lenses 17 are not necessarily finished after the processing in the device 1.

The transport device 15 has transport boxes 18. These do not necessarily need to be provided.

The workpiece spindle 7 is linearly displaceable in the direction y2.

In order to ensure that a non-represented drive of the workpiece spindle 7 and a non-represented mounting of the workpiece spindle 7 are protected against dirt and liquid and swarf, a bellows 19 is provided. The device 1 has a base stand 20 and a housing 25.

The tool holder 3 is mounted movably in the direction x1 on a linearly movable slide 21. The tool holder 3 is mounted rotatably from 0 to 360 degrees about the B1 axis and is positionable via a motorized adjustment.

Two tool-holding devices 22, 23 are arranged on the tool holder 3, which is designed as a rotary table, for example. A rotatably mounted, high-speed milling spindle 10 is arranged in the tool-holding device 22 and, on its lower side, a milling tool 12, in the present case a spherical cutter, is arranged, which is advantageously equipped with two to 15 milling edges. A linearly movable turning tool 9, which is advantageously designed as a fast tool, is arranged on the other side, offset by 180 degrees and parallel to the milling spindle 10, in an advantageously horizontal position. Two cutting bits 13 are arranged on the turning tool 9. This so-called linear fast tool can be designed with one or even two turning tools. These tools are arranged in the first work area A1.

In the second work area A2, a B2 axis is provided, which is arranged so as to be rotated by 90 degrees with respect to the first B1 axis. This B2 axis is also rotatable by 0 to 360 degrees and driven via a motor system (not represented). This axis is positionable. A rotatably mounted workpiece spindle 7 is centrally arranged on this axis B2. This axis B2 is connected to the linear axis y1 via a holder 24. It can move horizontally back and forth in relation to the base unit 2. It can move and position itself in a motorized manner along the y1 axis.

In the second work area A2, a further motorized axis B3, which is also rotatable and positionable by 0 to 360 degrees, is provided above the base unit 2. This axis B3 is vertically adjustable in the direction z1. In the design represented in FIGS. 1 through 6, this is a vertical adjustment. This orientation is not absolutely necessary, however.

The magazine 4 is arranged in the axis B3. The magazine 4 can accommodate four to twelve workpiece holders 5 or even another number of workpiece holders. The magazine 4 is designed for differently designed workpiece holders 5 for various spectacle lens blank types.

A loading and unloading device 6, which can be positioned in the direction y2, is arranged in the third work area A3. Transport boxes 18 are arranged on the transport device 15 and supply the spectacle lens blanks 16 and transport the fully processed spectacle lenses 17 away. The device 1 has a robot or a cobot. The robot or the cobot picks up one spectacle lens blank 16 from the transport device 15 or deposits a processed spectacle lens blank, i.e., a spectacle lens 17, in the transport device 15.

The housing 25 acts on the one hand as a splash guard and on the other hand performs safety functions.

The base unit 2 can advantageously consist of polymer concrete, granite, or, for example, a gray cast iron, which is filled with core sand. The base unit 2 is advantageously vibration-isolated and optimized by means of a modal analysis. The base stand 20 is connected to the base unit 2 via a fastening device 26. In the embodiment according to FIG. 5, a base stand 20 is not present, but rather only the base unit 2. Feet 27 are arranged on the base unit 2 or on the base stand 20.

In FIGS. 2, 3, 4 and 5, a collection container 32 is provided for liquid that is used in the processing operations and for the removed swarf. The collection container 32 has a drain 33.

### The processing of a spectacle lens blank in the device 1 is carried out as follows:

In the first work area A1, in the starting position, the milling spindle 10 is oriented in the direction of the workpiece spindle 7. The milling spindle 10 is positioned precisely toward the center of the workpiece spindle 7.

The workpiece spindle 7 in the fourth work area A4 is positioned in such a way that the empty workpiece spindle 7 points in the direction of the second work area A2. The retainer 14 on the workpiece spindle 7 points in the direction of the magazine 4. The loading and unloading device 6 stands vertically over the spectacle lens blank 16. The magazine 4 is positioned in such a way that a workpiece holder 5, which corresponds to the convex front curve of the spectacle lens blank 16, is arranged vertically over the workpiece spindle 7.

When a start command is triggered, a loading hatch 28 opens. The magazine 4, which is designed as a round magazine plate, for example, travels downward along the z1 axis and brings a workpiece holder 5 into a retainer 14 of the workpiece spindle 7. The workpiece holder 5 is fastened to the retainer 14 of the workpiece spindle 7. The magazine 4 travels along the y1 axis back into the work area A2. The loading hatch 28 closes. Then, the workpiece spindle 7 with the retainer 14 and the workpiece holder 5 rotates in the direction of the third work area A3. Next, a loading hatch 29 opens. The loading and unloading device 6 grips the spectacle lens blank 16 with a gripper or vacuum suction device 30 and transports the spectacle lens blank 16 with the convex side toward the workpiece holder 5. On this workpiece holder 5, the spectacle lens blank 16 is arranged on the workpiece holder 5. The workpiece holder 5 can be designed as a vacuum mount or an adhesion holder. Other fastening possibilities are also conceivable. If the workpiece holder 5 is designed as a vacuum mount, a vacuum connection is implemented in the workpiece spindle 7. If the workpiece holder 5 is designed as an adhesion holder, a vacuum connection is not necessary.

Then, the loading hatch 29 closes and the spectacle lens blank 16 is brought into the work area A1 by rotation of the workpiece spindle 7 about the axis B2. Then, the milling operation begins for the rough processing of the spectacle lens blank 16. The surface that is produced corresponds to the calculated freeform prescription. One possible processing is described below.

The processing is carried out, for example, in a movement about the workpiece spindle axis s1 from the rim to the center of the spectacle lens blank 16. Other kinematics are also possible, however.

In the milling processing, the spindle axis s1, the linear axis x1 and the transverse axis y1 interpolate.

When this work process has been completed, the tool holder 3 travels away from the workpiece spindle 7 in the x1 direction. The milling tool 8 is then located outside of a splash guard housing 31.

As soon as the milling tool 8 is arranged outside of the splash guard housing 31, the tool holder 3 rotates by 180 degrees about the axis B1 and positions the cutting bit 13, also referred to as a cutting edge, of the turning tool 9 (also referred to as a fast tool) in the direction of the workpiece spindle 7. After the positioning of the turning tool 9, the fine processing of the spectacle lens blank 16 begins via a turning process, which is carried out in the form of a specific path, for example, from the rim of the lens contour to the center of the lens. Since the surface of the spectacle lens is a non-rotationally shaped freeform surface, the turning tool 9 must move along the x2 axis during every revolution of the spectacle lens blank 16 and produces a portion of the freeform surface. At the same time, the axes s1, x1 and y1 interpolate. Due to the interpolation, the main x movement for producing the freeform surface is generated. Other movements or interpolations are also possible, however, in order to optimize processing properties.

The combination of the B2 axis positioning in connection with the x1 positioning is advantageously used in order to perfectly position the turning tool 9 with the cutting bit 13 toward the center of the workpiece spindle 7. As a result, the quality in the center of the spectacle lens 17 is optimized.

When the turning process has been completed, the turning tool 9 travels over the linear axes x1 and x2 into a base position. Thereafter, the workpiece spindle 7 rotates about the axis B2 in the direction of the third work area A3.

Here, the spectacle lens 17 is unloaded via the loading and unloading device 6. Then, the workpiece spindle 7 rotates about the axis B2 in the direction of the second work area A2. The workpiece holder 5 can then be deposited in the magazine 4 once again and the sequence begins again for the next spectacle lens blank 16.

If the next spectacle lens blank has the same front curve as the preceding spectacle lens blank 16, there is no need to change the workpiece holder 5.

In the following, the processing of a spectacle lens blank 16 in the manner shown in FIGS. 7 through 9, 10 and 14 is described.

FIG. 7 shows a spectacle lens blank 100 which has an outer rim 101. The spectacle lens blank also has a center 102.

A marking 115, which is designed as an orientation marking, for example, can be arranged on the spectacle lens blank 100.

According to FIG. 8, the spectacle lens blank 100 is subjected to rough processing, specifically with the milling tool 8, which has the spherical cutter 12. The rotational speed of the milling tool advantageously has a rotational speed between 50,000 and 80,000 revolutions per minute. The high-speed milling spindle 10 is used here. The milling spindle 10 is arranged at an angle α relative to the lens axis 103. The lens axis 103 extends through the center 102.

The milling operation proceeds in such a way that initially the outer rim 101 of the spectacle lens blank 100 is milled off to a standard diameter. The standard diameter can be 72.5 mm, for example.

Then, in a circular spiral that transitions into an elliptical spiral path and corresponds to the inner region 114, which can also be referred to as best-fit shape, all the projecting material of the spectacle lens blank 100 is milled off in such a way that the outer rim 101 remains intact and retains a minimal thickness of preferably approximately 2 mm to 0.3 mm, for example. Within the transition region from the outer rim 101 to the ellipse of the inner region 114, milling is carried out to a depth that is below the height along an edge 116. This height is advantageously 0.2 mm to 0.3 mm below the finished height. It can also have another height, however.

An edge 116 is formed on the contour line 104. This milling operation is represented in FIG. 8 with the spherical cutter 12. The height is designated with h in FIG. 8.

A contour line 105 designates the rim of the finished spectacle lens. As described above, the inner region 114 designates a best-fit shape, for example. In this work process, a free-standing ellipse 106 is produced. With the beginning of a contour line 104, the thickness of the spectacle lens surface 107 is processed in such a way that an allowance of, for example, 0.2 mm to 0.3 mm above the final spectacle lens thickness is produced in this area. This spectacle lens surface 107 is a so-called best-fit surface, for example. This spectacle lens surface 107 is a freeform surface, for example.

As a result, a height topography of the surface is manufactured, which, from the outer rim 101 to the contour line 104, does not correspond to the final topography of the finished spectacle lens but rather to a deeper surface and, starting at the contour line 104, corresponds to the subsequent spectacle lens surface 107 with a thickness allowance of 0.2 mm to 0.3 mm, for example. This yields a free-standing elliptical surface in the shape of an island on the spectacle lens surface 107.

In FIG. 9, the second work process with the turning tool 9 (turning tool is not represented in FIG. 9) with the cutting bits 13 is represented. In this second work process, the fine processing is carried out. In the fine processing, the allowance of, for example, 0.2 mm to 0.3 mm, beginning at the contour line 104, is removed. Since the surface of the finished spectacle lens 17 is considerably smaller than the surface of the overall spectacle lens along the outer rim 101, the processing time is considerably reduced, since fewer revolutions are necessary for the processing. Furthermore, the tool wear on the cutting bits 13 is also less, since less rotational distance is present.

The technological advantage can be up to 50%. Typically, a diameter of a spectacle lens is approximately 55 mm, which means that, for example, only approximately 920 revolutions are necessary for a planar surface in order to process the ellipse 106.

Since the rotational distance of the spiral decreases considerably with a smaller diameter, the effect on working time and wear is disproportionate to the savings in the number of revolutions, which is reduced.

In the method known from practical application, the entire surface of the spectacle lens blank 100 is processed with the turning tool beginning from the outer rim 101 to the center 102 of the spectacle lens blank. As compared to the invention, a considerably higher number of revolutions is necessary, for example 1,100 revolutions.

A further advantage of the processing according to the invention of the spectacle lens blank is that the raw thickness for a spectacle lens blank 100 can be reduced by approximately 50%, since the rim thickness of the spectacle lens along the contour line 105 is considerably less than at the outer rim 101 of the spectacle lens.

This relates to minus lenses in the present case.

For plus lenses, it is the other way around. Here, the necessary central thickness of the spectacle lens blank 100 is reduced.

A front surface 108 is not processed in the present exemplary embodiment.

During the milling processing and the processing with the turning tool with the cutting bits 13, the spectacle lens blank 100 rotates about the lens axis 103 according to the arrow P.

Due to the fact that the rim region 109 does not need to be processed with the turning tool, a considerable time savings is obtained in the processing and a considerable improvement of the useful life of the diamond tool for the fine processing is obtained.

FIG. 10 shows the spectacle lens blank 100 in which the rim region 109 has been processed by means of the milling tool 8. The height H is less than in a spectacle lens blank 110 according to FIG. 11, which belongs to the prior art, in which the entire spectacle lens surface 107 must be processed with a turning tool.

FIGS. 12 and 13 show a plus lens with a spectacle lens blank 110 belonging to the prior art. In FIG. 12, the spectacle lens blank 110 is shown prior to the processing. According to FIG. 13, the spectacle lens blank 110 has been processed and the outer rim 101 is designed to be very thin. This is also referred to as sharp-edged. In this spectacle lens blank 110 belonging to the prior art, there are problems with inserting the spectacle lens into a workpiece holder for further processing without it becoming damaged.

According to FIG. 14, a spectacle lens blank 100 which has the rim region 109 is represented. In FIG. 14, a raw piece 111 is represented with dashed lines. From this raw piece 111, the spectacle lens is manufactured by means of the milling tool 8 with the milling head 12. The contour line 105 indicates the width of the finished spectacle lens. The contour line 104 indicates the so-called best-fit shape of the spectacle lens.

The spectacle lens blank 100 has an outer diameter AD, which is 72.5 mm, for example.

The final spectacle lens 112 is formed within the contour line 105.

In FIG. 14, the rim region 109 is designed in such a way that a radius R is formed in the front surface in the rim region 109. This radius can be 7.5 mm, for example. It is also possible, however, to design the radius to be larger or smaller.

The radius creates a reinforcement in the rim region 109 when a plus lens is formed. Due to this negative radius R, an indentation 113 is obtained. The indentation 113 is arranged in the front surface 108 of the spectacle lens blank 100. Due to this embodiment, the rim region 109 is reinforced and a guide edge is obtained in contrast to the embodiment according to FIG. 13.

This embodiment has the advantage that the plus lenses have a guide edge and thus are easier to handle and are not damaged as quickly. With minus lenses, as represented in FIGS. 10 and 11, thinner raw pieces (blanks) with a lower height H are used.

Although only a few embodiments of the present invention have been shown and described, it is to be understood that many changes and modifications may be made thereunto without departing from the spirit and scope of the invention.

### REFERENCE NUMBERS

1 device
2 base unit
3 tool holder
4 magazine
5 workpiece holder
6 loading and unloading device
7 workpiece spindle
8 milling tool
9 turning tool
10 milling spindle
11 longitudinal axis of the milling spindle
12 spherical cutter
13 cutting bit
14 retainer
15 transport device
16 spectacle lens blanks
17 spectacle lens
18 transport box
19 bellows
20 base stand
21 slide
22 tool-holding device
23 tool-holding device
24 holder
25 housing
26 fastening device
27 feet
28 loading hatch
29 loading hatch
30 gripper/vacuum suction device
31 splash guard housing
32 collection container
33 drain
100 spectacle lens blank
101 outer rim
102 center
103 lens axis
104 contour line of inner region
105 contour line of finished spectacle lens
106 ellipse
107 spectacle lens surface
108 front surface
109 rim region
110 spectacle lens blank
111 raw piece
112 final spectacle lens
113 indentation
114 inner region
115 marking
116 edge at contour line 104
A1 tool holder work area
A2 magazine work area
A3 loading device work area
A4 spindle work area
AD outer diameter
B1 first axis (tool holder)
B2 second axis (workpiece spindle)
B3 third axis (magazine)
h height
H height of blank
n1 rotational speed of milling spindle
P arrow
R radius
s1 workpiece spindle axis
x1 direction
x2 direction
y2 direction
y1 axis
z1 direction αangle

What is claimed is:

1. A method for processing spectacle lens blanks for manufacturing spectacle lenses with at least one milling operation and at least one turning operation, the method comprising milling off projecting material of the spectacle lens blank in the milling operation, carrying our fine processing of the milled surface of the spectacle lens blank in the turning operation, wherein the spectacle lens blank has a rim region and an inner region in which the region of a final spectacle lens to be processed is arranged, wherein, by removing the projecting material in the rim region (109), an edge (104) delimiting the inner region (114) is formed, and wherein milling is carried out during the milling operation in the rim region (109) to a depth that is below the height of the edge (104) delimiting the inner region (114).

2. The method of claim 1, wherein the rim region (109) of the spectacle lens blank (100) remains intact at least during the milling operation and during the turning operation.

3. The method of claim 1, wherein a shape having a concave cross-section is formed in the rim region (109) during the milling operation, wherein the shape is milled between the outer rim (101) of the spectacle lens blank (100) and the edge (104) of the spectacle lens blank (100) delimiting the inner region (114).

4. The method of claim 1, wherein, in a first work step by means of a milling operation, the outer diameter of the spectacle lens blank (100) is milled off to a standard outer diameter, wherein the standard diameter is greater than the inner region (114).

5. The method of claim 1, wherein, in a circular spiral that transitions into an elliptical spiral path and corresponds to the freeform surface of the final spectacle lens, the projecting material of the spectacle lens blank (100) is milled off.

6. The method of claim 1, wherein the spectacle lens surface (107) is processed with the milling tool within the inner region (114) and wherein the spectacle lens surface (107) with an allowance is formed.

7. The method of claim 1, wherein the allowance is removed in a following fine processing operation.

8. The method of claim 7, wherein the fine processing operation is carried out with at least one turning tool (9).

9. The method of claim 1, wherein the rim region (109) is milled off after the fine processing or after a coating of the spectacle lens (112) or after another processing step.

10. A spectacle lens blank formed as a semi-manufactured product, manufactured according to the method of claim 1, wherein a surface is formed in the inner region (114) that is free-standing and projects over the remaining spectacle lens blank (100) and is elliptical in top view.

11. The spectacle lens blank of claim 10, wherein the projecting surface, which is elliptical in top view, is in the form of a freeform surface for the spectacle lens (112) to be manufactured, plus an allowance.

12. The spectacle lens blank of claim 10, wherein the allowance is between 0.1 mm and 0.5 mm.

13. A device for carrying out the method of claim 1 for processing spectacle lens blanks with at least two tools, wherein the device has a plurality of work areas, wherein a loading device for the spectacle lens blanks and an unloading device for the spectacle lenses manufactured from the spectacle lens blanks are arranged in one work area,
wherein
a tool holder (3), which is rotatable about a first axis (B1), with at least two tool-holding devices (22, 23) for the tools (8, 9) is arranged in a first work area (A1),
a magazine (4) for at least two workpiece holders (5) is provided in a second work area (A2),
the loading and unloading device (6) is arranged in a third work area (A3), and
a fourth work area (A4) is provided, in which a workpiece spindle (7) with a retainer (14) for a workpiece holder (5) is arranged, wherein the workpiece spindle (7) is designed to be positionable about a second axis (B2).

14. The device of claim 13, wherein the first axis (B1) and the second axis (B2) are oriented perpendicularly to one another.

15. The device of claim 13, wherein the workpiece spindle (7) is designed to be positionable about the second axis (B2) in the direction of the first or of the second or of the third work area (A1, A2, A3).

16. The device of claim 13, wherein the workpiece spindle (7) is designed to be additionally driven rotationally about a spindle axis (s1).

17. The device of claim 13, wherein the first and the second and the third work areas (A1, A2, A3) are arranged radially with respect to the second axis (B2) of the workpiece spindle (7).

18. The device of claim 13, wherein a milling tool (8) and a turning tool (9) having at least one cutting bit (13) for processing a surface (107) of the spectacle lens blanks (16) are arranged in the tool-holding devices (22, 23).

19. The device of claim 13, wherein the tool holder (3), which is rotatable about a first axis (B1) and arranged in the first work area (A1), is designed to be linearly displaceable.

20. The device of claim 13, wherein the workpiece spindle (7) with the retainer (14) for the workpiece holder (5) is designed to be linearly displaceable perpendicularly to its longitudinal axis and in the direction of the second axis (B2).
